(19) United States
(12) Patent Application Publication
(10) Pub. No.: US 2020/0195676 A1
(43) Pub. Date: Jun. 18, 2020

(54) NETWORK TELEPHONY ANOMALY DETECTION IMAGES

(71) Applicant: MICROSOFT TECHNOLOGY LICENSING, LLC, Redmond, WA (US)

(72) Inventors: Amer Hassan, Kirkland, WA (US); David Anthony Lickorish, Sammamish, WA (US); Michael Travis Gilbert, Thornton, CO (US); Bradford R. Clark, Broomfield, CO (US); Joshua Calvin Jenkins, Woodinville, WA (US)

(73) Assignee: MICROSOFT TECHNOLOGY LICENSING, LLC, Redmond, WA (US)

(21) Appl. No.: 16/798,558

(22) Filed: Feb. 24, 2020

Related U.S. Application Data
(62) Division of application No. 15/345,491, filed on Nov. 7, 2016.

(51) Int. Cl. H04L 29/06; H04M 7/00

(52) U.S. Cl. CPC H04L 63/1425; H04M 7/0078; H04M 3/2281; H04M 2201/42; H04M 7/0084

(57) ABSTRACT

In a device including a processor and a memory in communication with the processor, the memory includes executable instructions that, when executed by the processor, cause the processor to control the device to perform functions of monitoring a plurality of communication sessions among a plurality of endpoint devices in a network telephony platform; collecting characteristics of the endpoint devices; tracking metrics associated with the endpoint devices with respect to the communication sessions; and generating a map representing the characteristics and metrics associated with the endpoints, wherein the map represents the characteristics of the endpoint devices as relative spatial relationships among the endpoint devices.

### CROSS-REFERENCE TO RELATED APPLICATIONS

This application is a divisional of co-pending U.S. patent application Ser. No. 15/345,491, titled “NETWORK TELEPHONY ANOMALY DETECTION IMAGES”, filed on Nov. 7, 2016, which is incorporated hereto by reference in its entirety.

### BACKGROUND

Network telephony systems and applications, such as Voice over Internet Protocol (VoIP) systems and Skype® systems, have become popular platforms for not only providing voice calls between users, but also for video calls, live meeting hosting, interactive white boarding, and other point-to-point or multi-user network-based communications. These network telephony systems typically rely upon packet communications and packet routing, such as the Internet, instead of traditional circuit-switched communications, such as the Public Switched Telephone Network (PSTN) or circuit-switched cellular networks. In many examples, communication links can be established among endpoints, such as user devices, to provide voice and video calls or interactive conferencing within specialized software applications on computers, laptops, tablet devices, smartphones, gaming systems, and the like. As these network telephony systems have grown in popularity, various network anomalies, security breaches, and fraud have also become a greater concern. These issues can be especially difficult in identifying offending parties or discriminating when actual anomalies occur.

### SUMMARY

In an implementation, a device includes a processor and a memory in communication with the processor. The memory includes executable instructions that, when executed by the processor, cause the processor to control the device to perform functions of monitoring a plurality of communication sessions among a plurality of endpoint devices in a network telephony platform; collecting characteristics of the endpoint devices; tracking metrics associated with the endpoint devices with respect to the communication sessions; and generating a map representing the characteristics and metrics associated with the endpoints, wherein the map represents the characteristics of the endpoint devices as relative spatial relationships among the endpoint devices.

In another implementation, a method for operating a device for generating a map of a plurality of endpoint devices involved in a plurality of communication sessions in a network telephony platform, includes monitoring the plurality of communication sessions among the plurality of endpoint devices in the network telephony platform; collecting characteristics of the endpoint devices; tracking metrics associated with the endpoint devices with respect to the communication sessions; and generating a map representing the characteristics and metrics of the endpoint devices, wherein the map represents the characteristics of the endpoint devices as relative spatial relationships among the endpoint devices.

In another implementation, a non-transitory computer readable medium contains instructions which, when executed by a processor, cause a computer to perform functions of monitoring a plurality of communication sessions among a plurality of endpoint devices in a network telephony platform; collecting characteristics of the endpoint devices; tracking metrics associated with the endpoint devices with respect to the communication sessions; and generating a map representing the characteristics and metrics of the endpoint devices, wherein the map represents the characteristics of the endpoint devices as relative spatial relationships among the endpoint devices.

This Summary is provided to introduce a selection of concepts in a simplified form that are further described below in the Technical Disclosure. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 is a system diagram of a network telephony environment in an implementation.

FIG. 2 illustrates a method of operating a network telephony monitoring system in an implementation.

FIG. 3 is a system diagram of a network telephony environment in an implementation.

FIG. 4 illustrates example anomaly detection images in an implementation.

FIG. 5 illustrates an example computing platform for implementing any of the architectures, processes, methods, and operational scenarios disclosed herein.

### TECHNICAL DISCLOSURE

Network communication systems and applications, such as Voice over Internet Protocol (VoIP) systems, Skype® systems, Skype® for Business systems, Microsoft Lync® systems, and online group conferencing, can provide voice calls, video calls, live information sharing, and other interactive network-based communications. Communications of these network telephony and conferencing systems can be routed over one or more packet networks, such as the Internet, to connect any number of endpoints. More than one distinct network can route communications of individual voice calls or communication sessions, such as when a first endpoint is associated with a different network than a second endpoint. Network control elements can communicatively couple these different networks and can establish communication links for routing of network telephony traffic between the networks.

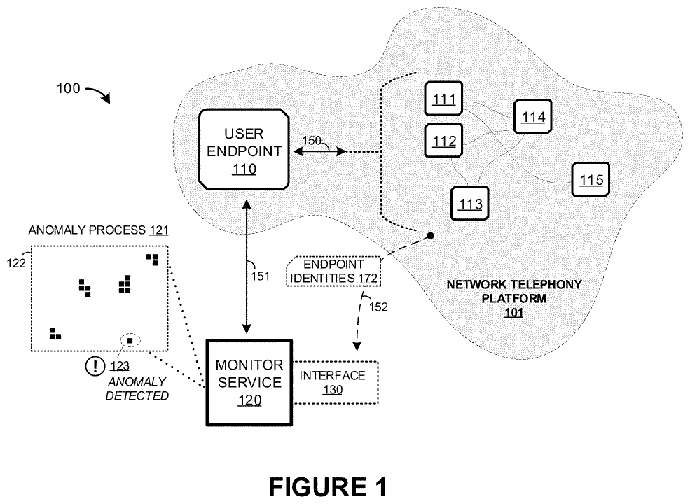

To provide enhanced operation of network telephony monitoring and anomaly detection systems, various examples are provided below. In a first implementation, FIG. 1 is a system diagram of network telephony environment 100. Environment 100 includes network telephony platform 101, user endpoint devices 110-115, monitor service 120, anomaly process 121, and interface 130. Endpoint devices can include monitor service 120, or monitor service 120 can instead be associated with network telephony platform 101, or portions thereof. Endpoint devices 110-115 can provide various data to monitor service 120 over associated links 151 and 152.

Endpoint devices 110-115 can engage in communication sessions, such as calls, conferences, messaging, and the like. For example, endpoint device 110 can establish a communication session over link 150 with any other endpoint device, including more than one endpoint device. Endpoint identifiers are associated with the various endpoints that communicate over the network telephony platform. These endpoint identifiers can include node identifiers, network addresses, aliases, or telephone numbers, among other identifiers. For example, endpoint device 110 might have a telephone number associated therewith, and other users or endpoints can use this telephone number to initiate communication sessions with endpoint device 110. Other endpoints can each have associated telephone numbers or other endpoint identifiers.

Anomalies can occur with regard to the various endpoint devices in FIG. 1, as well in general with network telephony platform 101. These anomalies can include faults or errors, but also can include fraudulent activities. Fraudulent activities can include malicious actors or malicious endpoint activity that can cause harm to various legitimate endpoint devices or the network platform itself. For example, a fraudulent call might be placed to an endpoint to harm that endpoint. These fraudulent calls or other anomalous activities can degrade operation of network platforms and directly affect endpoint devices and data associated with endpoint users.

Anomaly detections, such as fraud detection, can be performed on a per-endpoint basis. However, fraud can follow various patterns among groups of numbers that include multiple outgoing and incoming calls from different endpoint identifiers. The examples herein discuss various techniques and processes for anomaly detection across many different communication sessions and endpoint devices using image rendering and image processing techniques. Various cross-correlation of endpoints using the image processing techniques are provided.

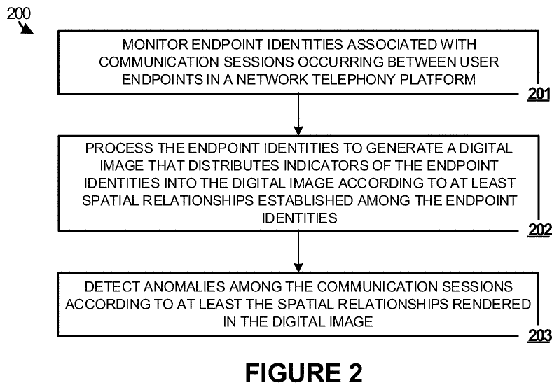

As a first example operation, FIG. 2 is provided. FIG. 2 is a flow diagram illustrating example operation of the elements of FIG. 1. In FIG. 2, monitor service 120 monitors (201) endpoint identities 172 associated with communication sessions occurring between user endpoints in a network telephony platform. The endpoint identities comprise identifiers individually associated with each endpoint that communicates over network telephony platform 101. These identifiers can comprise telephone numbers, device identifiers, network addresses, aliases, or other identifiers that uniquely identify each endpoint.

Monitor service 120 collects information on communication sessions that occur between one or more endpoint devices, including the associated endpoint identifiers. Associated communication session times and other properties can also be collected. This information can be provided over interface 130, which can comprise one or more network links, application programming interfaces (APIs), or other physical or logical interfaces. Links 151-152 in FIG. 1 illustrate example pathways for providing this information to monitor 120. Once the information on the communication sessions is received, monitor service 120 can store data indicating the endpoint identifiers in any number of storage services, such as cloud storage services or data centers associated with monitor service 120.

Monitor service 120 employs anomaly process 121 to process (202) the endpoint identities to generate one or more digital images 122 that each distributes indicators of the endpoint identities into the associated digital image according to at least spatial relationships established among the endpoint identities. A mapping process can be performed to construct a multi-dimensional image using various criteria associated with the endpoint identities. These criteria can include geographic regions or properties of the endpoint identities themselves. For example, when the endpoint identities comprise telephone numbers, area codes can be used as the criteria, along with other information such as a geographic area associated with the area codes. In a specific example, anomaly process 121 can map endpoint identities having a same area code using pixels that are closer in the image than pixels representing endpoint identities having different area codes. In this manner, anomaly process 121 can map endpoint identities in a same or similar geographic region using pixels of the image that are proximate to each other, and anomaly process 121 can map endpoint identities in different geographic regions using pixels that are more distant from each other.

Image 122 can be multi-dimensional, such as a 2-dimensional, 3-dimensional, or N-dimensional image. The number of axes or dimensions can indicate the number of endpoint identities selected for representation or mapping in image 122. For example, an organization or subset of an organization can be represented in image 122. Images can grow to be large in size for an entire organization, and thus a subset of the organization can be represented in an image. In further examples, a single monitored endpoint identifier might have a dedicate image constructed therefor, and pixels in the image represent other endpoint identifiers with which the monitored endpoint identifier has engaged in communications.

Construction of image 122 can consider one or more metrics associated with the endpoint identifiers. The metrics can include a number of calls associated with each particular endpoint identifier, a time or duration of the call/communication session, or other metrics. Pixel properties or amplitudes can indicate higher levels among the metrics. For example, a color of a pixel can indicate a number or quantity of calls or communication sessions associated with a particular pixel that represents an endpoint identifier. Other pixel properties can be employed to represent the metrics with respect to an indicated endpoint identifier, such as brightness, contrast, hue (color), saturation, size, or other properties. A spectrum of color or hue can be established so an operator can visually identify a pixel property indicating a degree or quantity associated with a particular metric.

Image 122 can be constructed to show behavior of many endpoint identifiers to many endpoint identifiers over some selected set, such as over a particular network or subset of a network. For example, the network might include a network telephony network represented by platform 101. This platform 101 might comprise a Voice over Internet Protocol (IP) network, and might include various routing nodes and egress/ingress nodes to interface with PSTN or switched telephone networks, among other networks. our purpose, the network is a voice network. Each user of platform 101 can have an endpoint identifier, such as Telephone Number (TN) assigned thereto for communication with each other and non-network users over egress nodes and associated PSTN networks. However, any communication network with endpoint devices that have assigned endpoint identifiers can be represented by anomaly process 121.

An initial image 122 might be flat, blank, or monotone in pixel property, and as communication sessions are monitored, associated pixels can be modified to reflect the communication sessions. Image 122 starts forming once communication sessions are being made among endpoint identifiers represented in the image. Over time, image 122 changes as more communication sessions occur or new endpoint identifiers engage in communication sessions with each other. These changes over time can be used to detect anomalies among the endpoints, such as fraud events or malicious activity.

Anomaly process 121 can detect (203) anomalies among the communication sessions according to at least the spatial relationships rendered in the digital image. Image 122 can be processed by anomaly process 121 for transients, locations of transients, and levels of transients, among other information. Transients can indicate what has changed in image 122 and at what location in image 122 the changes have occurred. The location of transients indicate geographic locations of a set of endpoint identifiers that are indicated by pixels of the transients in image 122. The levels of transients can indicate an ‘energy’ of the transients, such as a low energy or high energy. The energy of the transients can be indicated by the pixel properties mentioned above.

Thresholds can be established for monitor service 120, such as by an administrator or operator, to indicate when an anomaly should be reported once detected, or to indicate an anomaly detection. Depending on where the energy falls within one or more thresholds can indicate a severity or seriousness of the “transient” and anomaly or fraud alert level. Transient detection for anomalies can be accomplished using multi-resolution wavelet techniques or Gabor transformations, among other image processing techniques. The multi-dimensional image can be transformed into a different domain for determination of sharp edges and uncommon behavior that indicates anomalies.

When an anomaly is detected, such as anomaly 123, endpoint identifiers associated with the anomaly is flagged by monitor service 120 for alerting an operator or administrator. This alert can indicate possible fraud is occurring with respect to the affected endpoints. Severity levels can be indicated in the alert. For example, “Severity 1” can indicate a function of the metrics associated with the anomaly/transient line exceeded an example threshold_1. “Severity 1” might be a ‘serious’ flag, and get immediate attention by an operator within 20 minutes. “Severity 2” can indicate when the function of the metrics is between example threshold_2 and threshold_1, and indicate a less serious alert than “Severity 1.” Further levels and thresholds can be defined, such as threshold levels for the pixel properties that represent the endpoint identifiers.

Referring back to the elements of FIG. 1, endpoint devices 110-115 each comprise transceiver circuitry, processing circuitry, and user interface elements. The transceiver circuitry typically includes amplifiers, filters, modulators, and signal processing circuitry. Endpoint devices 110-115 can also each include user interface systems, network interface card equipment, memory devices, non-transitory computer-readable storage mediums, software, processing circuitry, or some other communication components. Endpoint devices 110-115 can each be a wireless communication device, subscriber equipment, customer equipment, access terminal, smartphone, telephone, mobile wireless telephone, personal digital assistant (PDA), computer, app, network telephony application, video conferencing device, video conferencing application, e-book, mobile Internet appliance, wireless network interface card, media player, game console, or some other wireless communication apparatus, including combinations thereof.

Monitor node 120 comprises computer processing systems and equipment which can include communication or network interfaces, as well as computer systems, microprocessors, circuitry, cloud-based systems, or some other processing devices or software systems, and can be distributed among multiple processing devices. Examples of monitor node 120 can also include software such as an operating system, logs, databases, utilities, drivers, networking software, and other software stored on a computer-readable medium. Monitor node 120 can provide one or more interface elements 130 which can receive endpoint identifiers and communication session information from endpoint devices or control nodes of platform 101. Interface elements 130 can be customized and instantiated specifically to interface with different types of control nodes or endpoints. In this manner, monitor node 120 and interface 130 can receive endpoint identifiers and communication session information from a plurality of control nodes or endpoints which might each communicate over a different protocol, link type, network type, and might each be operated by a different network operator or third-party network entity separate from that of monitor node 120.

Communication links 150-152 each use metal, glass, optical, air, space, or some other material as the transport media. Communication links 150-152 each can use various communication protocols, such as Internet Protocol (IP), Ethernet, WiFi, Bluetooth, synchronous optical networking (SONET), asynchronous transfer mode (ATM), Time Division Multiplex (TDM), hybrid fiber-coax (HFC), circuit-switched, communication signaling, wireless communications, or some other communication format, including combinations, improvements, or variations thereof. Communication links 150-152 each can be a direct link or may include intermediate networks, systems, or devices, and can include a logical network link transported over multiple physical links. In some examples, link 150-152 each comprises wireless links that use the air or space as the transport media.

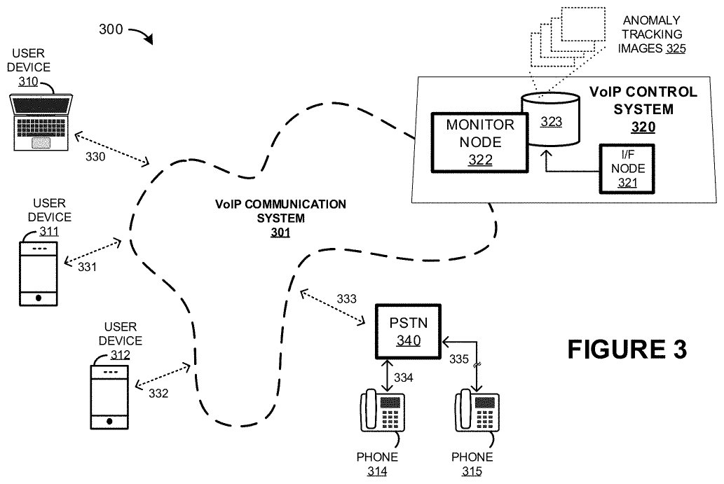

FIG. 3 illustrates a further example of a communication environment in an implementation. Specifically, FIG. 3 illustrates network telephony environment 300. Environment 300 includes VoIP communication system 301, VoIP control system 320, user devices 310-312, telephones 314-315, and public switched telephone network (PSTN) 340. User devices 310-312 comprise user endpoint devices in this example, and each communicates over an associated communication link that carries VoIP media legs for communication sessions. User devices 310-312 communicate over system 301 using associated links 330-332. Phones 314-315 also comprise user endpoints and communicate over associated local loop links 334-335 over PSTN 340. PSTN 340 can communicate over system 301 using at least link 333, which can comprise one or more ingress/egress bridging nodes that handle border control of communications between a VoIP system and PSTN system.

Monitor node 322 can receive quality metrics from an associated I/F node 321 in VoIP control system 320 which receives endpoint identifiers, such as telephone numbers, and communication system metrics from associated endpoints or from network elements that handle transport of VoIP communications. The endpoint identifiers and metrics can be stored in anomaly data storage system 323 which comprises one or more anomaly tracking images 325.

In multi-user VoIP call or group conferencing VoIP operations, user devices can initiate a VoIP call or conference, which might include other endpoints included over video, audio, or other media formats. For example, a user of user device 310 can establish a conference call within an application executed on user device 310. Responsive to the initiation of the multi-user VoIP call, user device 310 can communicate with any of the other endpoints that join the conference. Similar communication links and media legs can be established as discussed above for two-party VoIP call scenarios, and for call scenarios that span multiple networks, such as over PSTN 340 to conventional telephones 314-315.

In operation, monitor node 321 monitors endpoint identities associated with communication sessions occurring between user endpoints over VoIP communication system 301. In this example, telephone numbers comprise the endpoint identities, but other endpoint identifiers can instead be employed. Monitor node 321 can receive telephone numbers associated with calls or communication sessions occurring over VoIP communication system 301, along with associated metrics that comprise call durations or other information. Monitor node 321 processes the telephone numbers to generate one or more digital images that each distributes indicators of the telephone numbers into the digital images according to at least spatial relationships established among the telephone numbers. The digital images are represented in FIG. 3 by anomaly tracking images 325 stored in data storage system 323. Monitor node 321 then detects anomalies among the communication sessions according to at least the spatial relationships rendered in the digital images.

The spatial relationships can comprise geographic relationships, such as geographic area codes associated with the telephone numbers. However, to represent the area code locations in the digital images, a scaling factor can be applied to distribute the telephone numbers within the image. Monitor node 321 can determine the spatial relationships based at least on determining geographic distances among the endpoints and translating the geographic distances to a pixel distance applied to the indicators of the endpoint identities in the digital images. Monitor node 321 can determine the geographic distances by at least processing area codes associated with telephone numbers comprising the endpoint identities to establish geographic relationships or geographic distances among the telephone numbers.

Monitor node 321 distributes the indicators in a digital image by at least selecting indicator pixels in the digital image to represent each of the communication sessions, wherein the indicator pixels can be distributed according to the spatial relationships established for the telephone numbers. For example, the spatial relationships might comprise geographic distances translated to pixel distances in the digital image from an origin. More than one communication session can be represented in the digital image using some form of amplitude representation. The amplitude representation can comprise a pixel property or pixel overlap. For example, based at least on one or more of the communication sessions corresponding to a target pixel in the digital image, monitor node 321 selects a pixel property for the target pixel that corresponds to a quantity of the communication sessions that are indicated by the target pixel, where the pixel property comprises at least one of a pixel saturation, pixel hue, or pixel brightness, among other properties.

Monitor node 321 can then detect anomalies among the communication sessions by at least processing the digital image to determine domains within the digital image and identifying when one or more of the communication sessions comprise outliers from the domains. The domains can include groupings of pixels in the image corresponding to telephone numbers grouped by area code or geographic location and distributed into the image according to the spatial relationships. Image processing can be performed to translate the image data or pixel data into another representation for math-based processing within the other representation, such as Fourier transformations, wavelet processing, or other processing techniques. In some examples, multiple digital images are generated over time, and monitor node 321 can detect the anomalies among the communication sessions by at least processing an initial digital image against at least one further digital image produced to cover a different timeframe than the initial digital image, and identifying discontinuities between the initial digital image and the at least one further digital image. These discontinuities can correspond to anomalies, such as fraud or malicious activity.

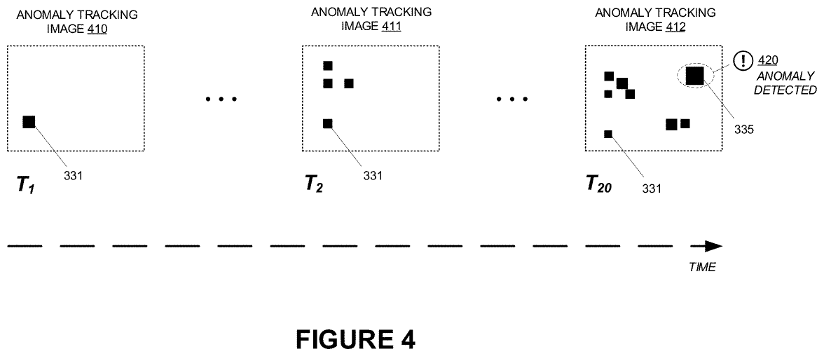

To further illustrate the use of digital images in anomaly detection, FIG. 4 is presented. FIG. 4 includes digital images 411-412 each representing a different timeframe. Monitor node 321 of FIG. 3 can establish the images of FIG. 4, and these images can comprise images 325 of FIG. 3.

In FIG. 4, at time window T₁ represented in image 410, a quantity of calls (e.g. 5 calls) from endpoint 310 to endpoint 311 can have pixel amplitude ‘5’ and average duration assigned. At time window T₂ represented in image 411, endpoint 310-to-endpoint 311 pixel amplitude goes down to perhaps 4, stays that way for a period of time. Endpoint 310 might have similar call behavior to other endpoints, such as endpoint 312, endpoint 313, and endpoint 314, among others in image 411. Then at time window Teo represented in image 412, endpoint 310 to endpoint 315 is has an amplitude of 50 (i.e. 50 calls), with durations that are above an average level associated with other calls. The transient detection algorithm of monitor node 321 can detect anomaly 420 associated with endpoint 315. Although pixel amplitude is illustrated in FIG. 4, other pixel properties can be employed, such as pixel color, pixel shading, or a number/value assigned to pixels that represents a pixel energy. The levels of transients can indicate an ‘energy’ of the transients, such as a low energy or high energy.

As discussed above, thresholds can be established for monitor node 321 to both detect anomalies or report anomalies. Depending on where the pixel properties fall within one or more thresholds can indicate a severity or seriousness of the “transient” and anomaly or fraud alert level. Transient detection for anomalies can be accomplished using multi-resolution wavelet techniques or Gabor transformations, among other image processing techniques. The multi-dimensional image can transformed into a different mathematical domain or numerical domain for determination of sharp edges and uncommon behavior that indicates anomalies.

When an anomaly is detected, such as anomaly 420, endpoint identifiers associated with the anomaly is flagged by monitor node 321 for alerting an operator or administrator. This alert can indicate possible fraud is occurring with respect to the affected endpoints. Severity levels can be indicated in the alert. Advantageously, a communication system, such as a network telephony platform can have powerful anomaly detection applied using the techniques discussed herein. The digital image-based anomaly detection can provide for detection of fraud, malicious activity, or other anomalies among endpoints. This has several technical effects comprising enhanced operation of network elements and network systems, faster detection of network anomalies among endpoints, reduced levels of fraud and malicious activity due to fast detection and alerting for further actions that inhibit the fraud or malicious activity, and overall enhanced user endpoint operation over large and complex network telephony systems.

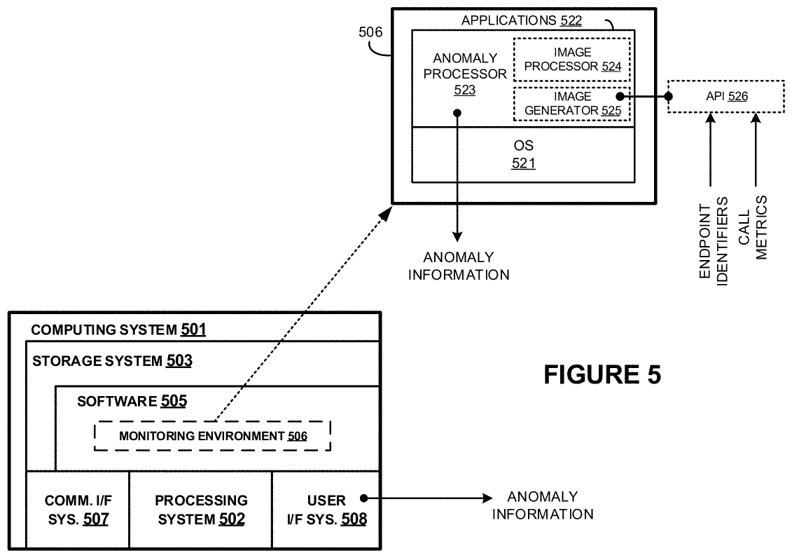

FIG. 5 illustrates computing system 501 that is representative of any system or collection of systems in which the various operational architectures, scenarios, and processes disclosed herein may be implemented. For example, computing system 501 can be used to implement any of monitor node 120 of FIG. 1 or monitor node 321 of FIG. 3. Examples of computing system 501 include, but are not limited to, server computers, cloud computing systems, distributed computing systems, software-defined networking systems, computers, desktop computers, hybrid computers, rack servers, web servers, cloud computing platforms, and data center equipment, as well as any other type of physical or virtual server machine, and other computing systems and devices, as well as any variation or combination thereof.

Computing system 501 may be implemented as a single apparatus, system, or device or may be implemented in a distributed manner as multiple apparatuses, systems, or devices. Computing system 501 includes, but is not limited to, processing system 502, storage system 503, software 505, communication interface system 507, and user interface system 508. Processing system 502 is operatively coupled with storage system 503, communication interface system 507, and user interface system 508.

Processing system 502 loads and executes software 505 from storage system 503. Software 505 includes monitoring environment 506, which is representative of the processes discussed with respect to the preceding Figures.

When executed by processing system 502 to enhance call monitoring and anomaly detection for VoIP systems, software 505 directs processing system 502 to operate as described herein for at least the various processes, operational scenarios, and sequences discussed in the foregoing implementations. Computing system 501 may optionally include additional devices, features, or functionality not discussed for purposes of brevity.

Referring still to FIG. 5, processing system 502 may comprise a micro-processor and processing circuitry that retrieves and executes software 505 from storage system 503. Processing system 502 may be implemented within a single processing device, but may also be distributed across multiple processing devices or sub-systems that cooperate in executing program instructions. Examples of processing system 502 include general purpose central processing units, application specific processors, and logic devices, as well as any other type of processing device, combinations, or variations thereof.

Storage system 503 may comprise any computer readable storage media readable by processing system 502 and capable of storing software 505. Storage system 503 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device, but may also be implemented across multiple storage devices or sub-systems co-located or distributed relative to each other. Storage system 503 may comprise additional elements, such as a controller, capable of communicating with processing system 502 or possibly other systems.

Software 505 may be implemented in program instructions and among other functions may, when executed by processing system 502, direct processing system 502 to operate as described with respect to the various operational scenarios, sequences, and processes illustrated herein. For example, software 505 may include program instructions for implementing call monitoring and anomaly detection for VoIP systems.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software or other application software, in addition to or that include monitoring environment 506. Software 505 may also comprise firmware or some other form of machine-readable processing instructions executable by processing system 502.

In general, software 505 may, when loaded into processing system 502 and executed, transform a suitable apparatus, system, or device (of which computing system 501 is representative) overall from a general-purpose computing system into a special-purpose computing system customized to facilitate enhanced call monitoring and anomaly detection for VoIP systems. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Monitoring environment 506 includes one or more software elements, such as OS 521 and applications 522. These elements can describe various portions of computing system 501 with which user endpoints, administrator systems, or control nodes, interact. For example, OS 521 can provide a software platform on which application 522 is executed and allows for receipt of endpoint identifiers and call metrics are received from endpoints or control nodes of a network telephony environment over API 526.

In one example, anomaly processor 523 includes API 526, image processor 524, and image generator 525. API 526 receives endpoint identifiers and call/communication session properties and metrics from endpoints or control nodes of a communication platform. Image generator 524 applies the endpoint identifiers and associated metrics to establish one or more digital images that represent the endpoint identifiers and associated metrics. Image processor 524 processes the digital images to identify one or more anomalies and generates alerts and anomaly information based on the detected anomalies.

In another example, monitoring environment 506 provides one or more outputs, which can be used to generate alerts, notify end users or network operators of the anomaly information, or other information. For example, anomaly or fraud alerts can be provided by user interface system 508, which provides statistics, information, status, or other data related to current VoIP anomalies as determined by anomaly processor 523.

Communication interface system 507 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. Physical or logical elements of communication interface system 507 can receive link/quality metrics, and provide link/quality alerts or dashboard outputs to users or other operators.

User interface system 508 is optional and may include a keyboard, a mouse, a voice input device, a touch input device for receiving input from a user. Output devices such as a display, speakers, web interfaces, terminal interfaces, and other types of output devices may also be included in user interface system 508. User interface system 508 can provide output and receive input over a network interface, such as communication interface system 507. In network examples, user interface system 508 might packetize display or graphics data for remote display by a display system or computing system coupled over one or more network interfaces. Physical or logical elements of user interface system 508 can provide alerts or anomaly informational outputs to users or other operators. User interface system 508 may also include associated user interface software executable by processing system 502 in support of the various user input and output devices discussed above. Separately or in conjunction with each other and other hardware and software elements, the user interface software and user interface devices may support a graphical user interface, a natural user interface, or any other type of user interface.

Communication between computing system 501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transmission control protocol (TCP), and the user datagram protocol (UDP), as well as any other suitable communication protocol, variation, or combination thereof.

Certain inventive aspects may be appreciated from the foregoing disclosure, of which the following are various examples.

### Example 1

A method of operating a network telephony anomaly service, comprising monitoring endpoint identities associated with communication sessions occurring between user endpoints in a network telephony platform, processing the endpoint identities to generate a digital image that distributes indicators of the endpoint identities into the digital image according to at least spatial relationships established among the endpoint identities, and detecting anomalies among the communication sessions according to at least the spatial relationships rendered in the digital image.

### Example 2

The method of Example 1, where the endpoint identities comprise telephone numbers associated with the user endpoints.

### Example 3

The method of Examples 1-2, further comprising determining the spatial relationships based at least on determining geographic distances among the endpoints and translating the geographic distances to a pixel distance applied to the indicators of the endpoint identities in the digital image.

### Example 4

The method of Examples 1-3, further comprising determining the geographic distances by at least processing area codes associated with telephone numbers comprising the endpoint identities.

### Example 5

The method of Examples 1-4, further comprising distributing the indicators in the digital image by at least selecting indicator pixels in the digital image to represent each of the communication sessions, where the indicator pixels are distributed according to geographic distances translated to pixel distances in the digital image from an origin.

### Example 6

The method of Examples 1-5, further comprising based at least on one or more of the communication sessions corresponding to a target pixel in the digital image, selecting a pixel property for the target pixel that corresponds to a quantity of the communication sessions that are indicated by the target pixel.

### Example 7

The method of Examples 1-6, where the pixel property comprises at least one of a pixel saturation, pixel hue, or pixel brightness.

### Example 8

The method of Examples 1-7, further comprising detecting the anomalies among the communication sessions by at least processing the digital image to determine domains within the digital image and identifying when one or more of the communication sessions comprise outliers from the domains.

### Example 9

The method of Examples 1-8, further comprising detecting the anomalies among the communication sessions by at least processing the digital image against at least one further digital image produced to cover a different timeframe than the digital image, and identifying discontinuities between the digital image and the at least one further digital image.

### Example 10

A network telephony anomaly service, comprising one or more computer readable storage media, a processing system operatively coupled with the one or more computer readable storage media, and an anomaly detection service comprising program instructions stored on the one or more computer readable storage media. Based on being read and executed by the processing system, the program instructions direct the processing system to at least monitor endpoint identities associated with communication sessions occurring between user endpoints in a network telephony platform, process the endpoint identities to generate a digital image that distributes indicators of the endpoint identities into the digital image according to at least spatial relationships established among the endpoint identities, and detect anomalies among the communication sessions according to at least the spatial relationships rendered in the digital image.

### Example 11

The display output control apparatus of Example 10, where the endpoint identities comprise telephone numbers associated with the user endpoints.

### Example 12

The display output control apparatus of Examples 10-11, comprising further program instructions, based on being executed by the processing system, direct the processing system to at least determine the spatial relationships based at least on determining geographic distances among the endpoints and translating the geographic distances to a pixel distance applied to the indicators of the endpoint identities in the digital image.

### Example 13

The display output control apparatus of Examples 10-12, comprising further program instructions, based on being executed by the processing system, direct the processing system to at least determine the geographic distances by at least processing area codes associated with telephone numbers comprising the endpoint identities.

### Example 14

The display output control apparatus of Examples 10-13, comprising further program instructions, based on being executed by the processing system, direct the processing system to at least distribute the indicators in the digital image by at least selecting indicator pixels in the digital image to represent each of the communication sessions, where the indicator pixels are distributed according to geographic distances translated to pixel distances in the digital image from an origin.

### Example 15

The display output control apparatus of Examples 10-14, comprising further program instructions, based on being executed by the processing system, direct the processing system to at least based at least on one or more of the communication sessions corresponding to a target pixel in the digital image, select a pixel property for the target pixel that corresponds to a quantity of the communication sessions that are indicated by the target pixel.

### Example 16

The display output control apparatus of Examples 10-15, where the pixel property comprises at least one of a pixel saturation, pixel hue, or pixel brightness.

### Example 17

The display output control apparatus of Examples 10-16, comprising further program instructions, based on being executed by the processing system, direct the processing system to at least detect the anomalies among the communication sessions by at least processing the digital image to determine domains within the digital image and identifying when one or more of the communication sessions comprise outliers from the domains.

### Example 18

The display output control apparatus of Examples 10-17, comprising further program instructions, based on being executed by the processing system, direct the processing system to at least detect the anomalies among the communication sessions by at least processing the digital image against at least one further digital image produced to cover a different timeframe than the digital image, and identifying discontinuities between the digital image and the at least one further digital image.

### Example 19

A Voice over Internet Protocol (VoIP) network anomaly detection system, comprising a monitor service configured to monitor telephone numbers associated with communication sessions occurring between user endpoints of the VoIP network, and an anomaly service configured to process the telephone numbers to generate a digital image that distributes indicators of the telephone numbers into the digital image according to at least spatial relationships established among the telephone numbers. The anomaly service is configured to detect anomalies among the communication sessions according to at least the spatial relationships rendered in the digital image.

### Example 20

The VoIP network anomaly detection system of Example 19, comprising the anomaly service configured to determine the spatial relationships based at least on determining geographic distances among the endpoints corresponding to area codes associated with the telephone numbers, and translating the geographic distances to a pixel distances from an origin applied to the indicators in the digital image. The anomaly service is configured to detect the anomalies among the communication sessions by at least processing the digital image to determine domains within the digital image and identifying when one or more of the communication sessions comprise outliers from the domains.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the present disclosure. Those skilled in the art will also appreciate that the features described above can be combined in various ways to form multiple implementations. As a result, the invention is not limited to the specific implementations described above, but only by the claims and their equivalents.

What is claimed is:

1. A device comprising:
a processor; and
a memory in communication with the processor, the memory comprising executable instructions that, when executed by the processor, cause the processor to control the device to perform functions of:
monitoring a plurality of communication sessions among a plurality of endpoint devices in a network telephony platform;
collecting characteristics of the endpoint devices;
tracking metrics associated with the endpoint devices with respect to the communication sessions; and
generating a map representing the characteristics and metrics associated with the endpoints, wherein the map represents the characteristics of the endpoint devices as relative spatial relationships among the endpoint devices.

2. The device of claim 1, wherein the characteristics of the endpoint devices comprises an endpoint identity of each endpoint device.

3. The device of claim 2, wherein the endpoint identity comprises a node identifier, network address, alias or telephone number of each endpoint device.

4. The device of claim 1, wherein the metrics associated with each endpoint device comprise a number of the communication sessions associated with each endpoint device or a duration of each communication session associated with each endpoint device.

5. The device of claim 1, wherein:
the characteristics of the endpoint devices comprise a phone number of each endpoint device, and
for generating the map, the instructions, when executed by the processor, further cause the processor to control the device to perform functions of:
determining, based on the phone number of each endpoint device, geographic distances among the endpoint devices; and
translating the determined geographical distances to the relative spatial relationships among the endpoint devices.

6. The device of claim 5, wherein, for generating the map, the instructions, when executed by the processor, further cause the processor to control the device to perform a function of distributing, based on the relative spatial relationships among the endpoint devices, a plurality of indicators representing the endpoint devices, respectively, on the map.

7. The device of claim 6, wherein a property of each indicator represents the metrics associated with the respective endpoint device.

8. The device of claim 7, wherein the instructions, when executed by the processor, further cause the processor to control the device to perform a function of updating the property of each indicator according to a change to the metrics associated with the respective endpoint device.

9. The device of claim 8, wherein the instructions, when executed by the processor, further cause the processor to control the device to perform a function of detecting, based on the property of each indicator, an anomaly among the endpoint devices.

10. The device of claim 9, wherein, for detecting the anomaly, the instructions, when executed by the processor, further cause the processor to control the device to perform functions of:
determining, based on the property of each indicator, a domain within the map; and
identifying, based on the domain within the map, that the indicator that is an outlier from the domain.

11. A method for operating a device for generating a map of a plurality of endpoint devices involved in a plurality of communication sessions in a network telephony platform, comprising:
monitoring the plurality of communication sessions among the plurality of endpoint devices in the network telephony platform;
collecting characteristics of the endpoint devices;
tracking metrics associated with the endpoint devices with respect to the communication sessions; and
generating a map representing the characteristics and metrics of the endpoint devices, wherein the map represents the characteristics of the endpoint devices as relative spatial relationships among the endpoint devices.

12. The method of claim 11, wherein the characteristics of the endpoint devices comprise an endpoint identity of each endpoint device.

13. The method of claim 12, wherein the endpoint identity comprises a node identifier, network address, alias or telephone number of each endpoint device.

14. The method of claim 11, wherein the metrics associated with each endpoint device comprise a number of the communication sessions associated with each endpoint device or a duration of each communication session associated with each endpoint device.

15. The method of claim 11, wherein:
the characteristics of the endpoint devices comprise a phone number of each endpoint device, and
generating the map comprises:
determining, based on the phone number of each endpoint device, geographic distances among the endpoint devices; and
translating the determined geographical distances to the relative spatial relationships among the endpoint devices.

16. The method of claim 15, wherein:
generating the map further comprises distributing, based on the relative spatial relationships among the endpoint devices, a plurality of indicators representing the endpoint devices, respectively, on the map, and
a property of each indicator represents the metrics associated with the respective endpoint device.

17. The method of claim 16, further comprising updating the property of each indicator according to a change to the metrics associated with the respective endpoint device.

18. The method of claim 17, further comprising detecting, according to the property of each indicator, an anomaly among the endpoint devices.

19. The method of claim 18, wherein detecting the anomaly among the endpoint devices comprises:
determining, based on the property of each indicator, a domain within the map; and
identifying, based on the domain within the map, that the indicator that is an outlier from the domain.

20. A non-transitory computer readable medium containing instructions which, when executed by a processor, cause a computer to perform functions of:
monitoring a plurality of communication sessions among a plurality of endpoint devices in a network telephony platform;
collecting characteristics of the endpoint devices;
tracking metrics associated with the endpoint devices with respect to the communication sessions; and
generating a map representing the characteristics and metrics of the endpoint devices, wherein the map represents the characteristics of the endpoint devices as relative spatial relationships among the endpoint devices.
